(19) United States
(12) Patent Application Publication
(10) Pub. No.: US 2014/0032386 A1
(43) Pub. Date: Jan. 30, 2014

(54) METHOD AND APPARATUS FOR EFFICIENT BANKING OPERATIONS

(71) Applicant: POLARIS FINANCIAL TECHNOLOGY LIMITED, Chennai, TN (US)

(72) Inventor: ARUN JAIN, CHENNAI (IN)

(73) Assignee: POLARIS FINANCIAL TECHNOLOGY LIMITED, Chennai, TN (US)

(21) Appl. No.: 13/954,937

(22) Filed: Jul. 30, 2013

(30) Foreign Application Priority Data
Jul. 30, 2012 (IN) 3093/CHE/2012

(51) Int. Cl. G06Q 40/02

(52) U.S. Cl. CPC G06Q 40/02
USPC 705/35

(57) ABSTRACT

Various embodiments of the invention comprise an apparatus and method for providing improved banking operations. In one embodiment, the method includes decomposing data processing of a banking organization into multiple functions, and providing multiple widgets. Each of the multiple widgets performs a banking operation, and includes at least one of the multiple functions. The multiple widgets exhaustively represent the data processing of the banking organization exhaustively and perform mutually exclusive banking operations. In another embodiment, the method includes customizing a workspace of a computing terminal by rendering at least one of the multiple widgets in the workspace according to a preference including at least one of, role of user of the workspace with respect to the banking organization, and the like. In another embodiment, the method includes providing at least one of the multiple widgets based on a current context including at least one of, customer identity, and the like.

### CROSS-REFERENCE TO RELATED DOCUMENTS

This application claims priority from the Indian Non Provisional Patent Application No. 3093/CHE/2012 titled “Method And Apparatus For Efficient Banking Operations” filed on Jul. 30, 2013, which is the non provisional of the Indian Provisional Application No. 3093/CHE/2012 titled “Method And Apparatus For Efficient Banking Operations” filed on Jul. 30, 2012, both of which are incorporated herein by reference in their entireties.

### BACKGROUND

1. Field of the Invention

Embodiments of the present invention generally relate to banking systems, and more particularly, to a method and apparatus for increasing the efficiency of banking operations.

2. Description of the Related Art

Current banks operate with menu-based systems. Single transaction operation requires an average traversal through 7-8 menu screens. Screens/UI not intuitive for service providers (e.g. bank employees) and are even more difficult to use for customers, for example for self service. Overall, conventional systems in use today have a cumbersome and a non-intuitive process, and therefore suffer from longer transaction times.

Further, complex nature of conventional systems and transactions require a higher number of employees to complete the tasks, and higher training costs to train the employees on non-intuitive conventional banking systems. In many cases, when an employee leaves, the replacement employee needs to be trained extensively on the system as well as customer relation history.

Therefore, there is a need for a method and apparatus for improved and efficient banking.

### SUMMARY

Various embodiments of the invention comprises an apparatus and method for providing improved and efficient banking operations. In one embodiment, the method decomposes data processing of a banking organization into a plurality of functions, and providing a plurality of widgets, each of the plurality of widgets performing a banking operation, and each of the plurality of widgets comprising at least one of the plurality of finite functions, wherein the plurality of widgets exhaustively represent the data processing of the banking organization exhaustively and perform mutually exclusive banking operations.

In another embodiment, a method for customizing a workspace of a computing terminal of a banking organization is disclosed. The method comprises rendering at least one of a plurality of widgets in the workspace according to a preference, the preference comprising at least one of, role of user of the workspace with respect to the banking organization, time of use of the workspace and, a selection of the banking organization, wherein the plurality of widgets are mutually exclusive and represent data processing of the banking organization exhaustively.

In a yet another embodiment, a method for banking is disclosed. The method comprises providing at least one of a plurality of widgets based on a current context, each of the plurality of widgets comprising at least one of a plurality of data processing of a banking operation, and wherein the plurality of widgets exhaustively represent data processing of a banking organization and perform mutually exclusive banking operations and wherein the current context comprises at least one of operation type, customer identity, a customer attribute, date of the banking operation and, currency of the banking operation.

### BRIEF DESCRIPTION OF THE DRAWINGS

FIG. 1 depicts a schematic diagram of an apparatus for efficient banking according to an embodiment of the present invention.

FIG. 2 depicts a schematic diagram of an application server of FIG. 1 according to an embodiment of the present invention.

FIG. 3 depicts a schematic diagram of a client of FIG. 1 according to an embodiment of the present invention.

FIG. 4 depicts a flow diagram of a method for efficient banking according to an embodiment of the present invention.

FIG. 5 depicts a UI comprising a widget for natural language search according to an embodiment of the present invention.

FIG. 6 depicts a UI comprising multiple widgets including a cash deposit transaction widget according to an embodiment of the present invention.

FIG. 7 depicts a UI comprising multiple widgets including at least one widget providing customer centric information according to an embodiment of the present invention.

FIG. 8 depicts a UI for customizing a workspace according to an embodiment of the present invention.

FIG. 9 depicts a UI comprising at least one widget for customer self-service according to an embodiment of the present invention.

FIG. 10 depicts a computer system according to an embodiment of the present invention.

While the method and apparatus is described herein by way of example for several embodiments and illustrative drawings, those skilled in the art will recognize that the method and apparatus for efficient banking operations are not limited to the embodiments or drawings described. It should be understood, that the drawings and detailed description thereto are not intended to limit embodiments to the particular form disclosed. Rather, the intention is to cover all modifications, equivalents and alternatives falling within the spirit and scope of the method and apparatus for calculating participant engagement index in an online meeting as defined by the disclosed embodiments. Any headings used herein are for organizational purposes only and are not meant to limit the scope of the description or the embodiments. As used herein, the word “may” is used in a permissive sense (i.e., meaning having the potential to), rather than the mandatory sense (i.e., meaning must). Similarly, the words “include”, “including”, and “includes” mean including, but not limited to. Additionally, as used herein, the word “video” refers generally to any multi-media object or data, and although in various embodiments of the invention may refer to only a video object (still, animated or moving), in other embodiments, may refer to a combination of both video and audio objects or an audio object alone.

### DETAILED DESCRIPTION OF EMBODIMENTS

Embodiments of the present invention comprise a method and apparatus for efficient banking. The embodiments provide an easy, intuitive and comprehensive solution for all banking operations and all entities using such systems, including bank's customers, bank's employees or service providers including bank's administrative and managerial staff. Further, the embodiments eliminate the need for lengthy and complex menus, and provide an easy search and populate feature to enable a single click or two-click banking transactions.

Various embodiments of an apparatus and method for efficient banking are described. In the following detailed description, numerous specific details are set forth to provide a thorough understanding of the disclosed subject matter. However, it will be understood by those skilled in the art that disclosed subject matter may be practiced without these specific details. In other instances, methods, apparatuses or systems that would be known by one of ordinary skill have not been described in detail so as not to obscure disclosed subject matter.

Some portions of the detailed description which follow are presented in terms of algorithms or symbolic representations of operations on binary digital signals stored within a memory of a specific apparatus or special purpose computing device or platform. In the context of this particular specification, the term specific apparatus or the like includes a general purpose computer once it is programmed to perform particular functions pursuant to instructions from program software. Algorithmic descriptions or symbolic representations are examples of techniques used by those of ordinary skill in the signal processing or related arts to convey the substance of their work to others skilled in the art. An algorithm is here, and is generally, considered to be a self-consistent sequence of operations or similar signal processing leading to a desired result. In this context, operations or processing involve physical manipulation of physical quantities. Typically, although not necessarily, such quantities may take the form of electrical or magnetic signals capable of being stored, transferred, combined, compared or otherwise manipulated. It has proven convenient at times, principally for reasons of common usage, to refer to such signals as bits, data, values, elements, symbols, characters, terms, numbers, numerals or the like. It should be understood, however, that all of these or similar terms are to be associated with appropriate physical quantities and are merely convenient labels. Unless specifically stated otherwise, as apparent from the following discussion, it is appreciated that throughout this specification discussions utilizing terms such as “processing,” “computing,” “calculating,” “determining” or the like refer to actions or processes of a specific apparatus, such as a special purpose computer or a similar special purpose electronic computing device. In the context of this specification, therefore, a special purpose computer or a similar special purpose electronic computing device is capable of manipulating or transforming signals, typically represented as physical electronic or magnetic quantities within memories, registers, or other information storage devices, transmission devices, or display devices of the special purpose computer or similar special purpose electronic computing device.

Embodiments of the present invention provide a method and apparatus for efficient banking. Advantageously, embodiments enable all banking transactions of a bank branch in a simple, intuitive, comprehensive and powerful manner using computing devices that include, but are not limited to, tablet PCs, laptops, desktops, mobile phones, PDAs and similar devices having a processing device, a display unit and input/output unit, and a communication device to connect to other remote devices. Furthermore, the embodiments enable use of tablet PCs to enable a bank's employees to be mobile, customer centric and empowered with real time information to provide a high degree of customized attention to the customer, faster transactions, and overall generate customer relationship and loyalty. Even furthermore, the disclosed embodiments advantageously provide for more efficient bank employees, thereby reducing the number of employees required per customer and reducing the infrastructure requirements of a bank branch through simple, easy to use single interface.

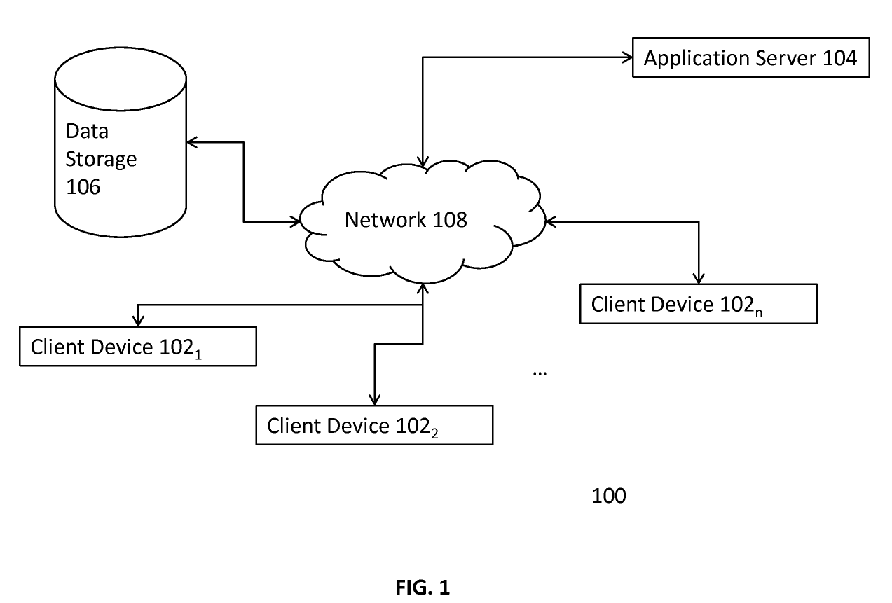

FIG. 1 depicts a block diagram showing an apparatus 100 for efficient banking, according to one or more embodiments of the invention. The apparatus 100 comprises at least one client device 102, (multiple client devices illustrated in FIG. 1 by numerals 102₁, 102₂, . . . 102ₙ), an application server 104, a data storage 106 and a network 108.

In some embodiments, the network 108may include one or more networks including but not limited to Local Area Networks (LANs) (e.g., an Ethernet or corporate network), Wide Area Networks (WANs) (e.g., the Internet), wireless data networks, some other electronic data network, or some combination thereof. In various embodiments, network interface may support communication via wired or wireless general data networks, such as any suitable type of Ethernet network, for example; via telecommunications/telephony networks such as analog voice networks or digital fiber communications networks; via storage area networks, such as Fiber Channel SANs, or via any other suitable type of network and/or protocol.

The client device 102, the application server 104 and the data storage 106 are computing devices configured for exchanging digital content over the network 108, processing and displaying such content and providing a user interface. The client device 102 is a computing device used by a bank's customers, employees and the like, for accessing and conducting banking operations. The application server 104 is a computing device that enables banking operations. The data storage 106 includes banking related information and data required for conducting various banking operations. In one embodiment, the data storage 106 includes profile information of customers of a bank, for example, previous transactions, transaction and/or investment preferences, in addition to basic information about the users such as birthday, anniversary, credit history profile and the like. Those skilled in the art will appreciate that the various functionalities of the client device 102, the application server 104 and the data storage 106 can be readily configured differently, for example, using the devices of the apparatus 100 for different functionality, or using other devices communicably coupled to the network 108 to achieve these functionalities, and similar such configurations, which are included within the scope and spirit of the invention.

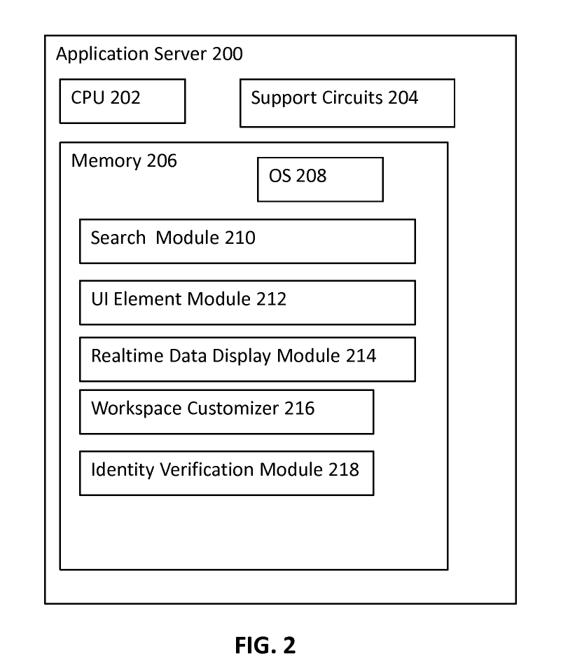

FIG. 2 depicts a block diagram of an application server 200 for efficient banking, for example, similar to the application server 104 of FIG. 1, according to one or more embodiments of the invention. In some embodiments, the application server 200 is a type of computing device (e.g., a laptop, a desktop, a Personal Digital Assistant (PDA) and/or the like) known to one of ordinary skill in the art. The CPU 202 may comprise one or more commercially available microprocessors or microcontrollers that facilitate data processing and storage. The various support circuits 204 facilitate the operation of the CPU 202 and include one or more clock circuits, for example a meeting timer, power supplies, cache, input/output circuits, displays, including touch sensitive displays and the like. The application server 200 further includes a memory 206. The memory 206 comprises at least one of Read Only Memory (ROM), Random Access Memory (RAM), disk drive storage, optical storage, removable storage and/or the like. The memory 206 includes an Operating System (OS) 208, a naturalized search module 210, a UI element module 212, a real time data display module 214, workspace customizer 216, and an identity verification module 218. In one embodiment (not shown) the application server 200 includes data storage, similar to the data storage 106 of FIG. 1.

According to some embodiments, the operating system (OS) 208 generally manages various computer resources (e.g., network resources, file processors, and/or the like). The operating system 208 is configured to execute operations on one or more hardware and/or software modules, such as Network Interface Cards (NICs), hard disks, virtualization layers, firewalls and/or the like. Examples of the operating system 208 may include, but are not limited to, Linux, Mac OSX, BSD, UNIX, Microsoft Windows, and the like.

In some embodiments, the search module 210 allows for searching for an entity. An entity may be a bank customer, a bank employee. In some embodiments, the search module 210 allows searching for a widget (described in detail below) for particular transaction types, for example, cash withdrawal, deposits and the like. In another embodiment, the search module 210 is configured to provide transaction information input by a user to populate a widget. In some embodiments, the search module 210 is configured to perform all the above operations simultaneously. For example, in one embodiment, a search query may include identification information, such as, for example, a phone number, an account number, a customer ID and the like. In this embodiment, the search query further includes the term “deposit cash”, and the search query further includes transaction information such as an amount of “$100”. In such an embodiment, the search module 210 is configured to identify the entity associated with the identification information, a widget for enabling the transaction type specified, and for providing transaction information for pre-populating the transaction widget. In some embodiments, the search module 210 is configured to receive date related information, such as the DD (from the DDMMYYYY), and provides a date value based on default assumptions to provide the most reasonable DDMMYYYY values. The user may accept or modify such provided date values.

According to some embodiments, the search module 210 includes Zolog Search methodology as described in Indian application number IN2010/000603 titled ‘ZologIntelligent Human Language Interface For Business Software Applications’ incorporated herein by reference in its entirety.

The UI Element module 212 includes a repository of user interface (UI) elements or widgets designed for performing banking operations efficiently. In some embodiments, the UI Elements are specially configured widgets, and hereinafter, the terms “UI Element” and “widget” has been used interchangeably. According to an embodiment, data processing of a banking organization is decomposed into multiple functions. Multiple widgets including one or more of these multiple functions are designed to exhaustively represent the data processing of the banking organization and perform mutually exclusive banking operations. For example, one of the multiple functions may be crediting an amount in an account. Such a finite function may be included in separate widgets for cash deposit and net transfer. The UI element module 212 provides the appropriate UI element or widget according to current context. The UI module 212 provides one or more of the multiple widgets according to a current context when a user is performing a banking transaction using a widget. The current context includes one or more of, operation type, customer identity, a customer attribute, date of the banking operation and, currency of the banking operation. The UI element module 212 further populates the widget with the entity information obtained using the identification information provided to the search module 210. The UI element module 212 further populates the widget with the transaction information if available. Accordingly, in several embodiments, the UI element module 212 is configured to provide a pre-populated widget for enabling a transaction. Further, according to various embodiments, the UI element module 212 receives confirmation for completing a transaction. The UI element module 212 is further configured to provide multiple widgets at the same time, depending upon current context and/or operations requested by a user. Advantageously, various embodiments as disclosed provide for parallel processing of multiple banking operations for a user. Conventional systems require completion of one function for a user to enable another transaction for the user. In some disclosed embodiments, multiple widgets are utilized for processing multiple transactions for a user, simultaneously or partially simultaneously. Thus, while one transaction for a user is being processed, another transaction for the user can be conducted, saving on valuable time and increasing productivity.

According to several embodiments, the UI Elements or widgets are provided by the UI element module 212 in based on role of the user with respect to the banking organization. For example, such roles include, teller, branch manager, customer service officer, relationship manager, administrators, product managers, auditors, and the like. According to various embodiments the standardized roles cover the functions of a bank or a financial institution in an exhaustive manner. Each role is associated with alerts, functionalities and action items. According to several embodiments, various banking operations required to be accomplished by various roles are accomplished by widgets, and in some embodiments, each widget corresponds to a single banking operation. Further, due to the comprehensive design, according to various embodiments, the widgets provide a consistent user experience across applications. Furthermore, according to several embodiments, widgets are structured around the current context, and are categorized into information, analysis, decision and transaction widgets. Information Widgets provide information about key business objects in a bank such as customer, product information. Analytic Widgets provide data for real time analysis and forecasting. Decision Widgets help users to make informed decisions, and Transaction Widgets aid the users to post transactions.

Widgets operationalize and fulfill one or more banking operations through one or more functions, and widgets include the user interface (UI) aspects of such functions. According to some embodiments, multiple widgets exhaustively cover all functions or operations for serving or operating a financial organization, such as a bank, and in such embodiments, for each function there exists at least one widget. According to some embodiments, widgets' functions or operations are mutually exclusive, that is, functions corresponding to one widget do not correspond to any other widget. According to several embodiments, the widgets are mutually exclusive and exhaustive, that is, the widgets cover all possible operations or functions required in a given financial organization environment, e.g. one or more verticals of a bank, and each of the function has only one corresponding widget. In such cases, it is permissible for a widget to have more than one function or operation mapping to the widget. Features of widgets described according to various embodiments discussed herein allow for an efficient scheme of widgets that are customizable according to the application environment, people, customers, time and other operating variables, well organized and therefore, easy to operate.

According to several embodiments, such widgets are made possible by decomposing all possible operations of an organization, e.g. a vertical of a banking organization, into finite functions. The finite functions are advantageously categorized as Information (I), Analytics (A), Decision (D) and Transaction (T) widgets, and the categorization scheme is sometimes referred to as the IADT technique. The IADT technique allows for efficient organization of functions, and therefore, an effective designing of widgets embodying such functions. One property of the functions is that each function is finite, that is, can complete the desired operation substantially independently, and the finite function is not dependent on other functions for its execution. Finiteness lends a standalone character to functions. Decomposition to finite functions, therefore, advantageously breaks any financial organizations desired operations into a finite number of standalone functions, that may interact, but can fulfill their own purpose independently.

The mutually exclusive and exhaustive widgets use the finite functions intelligently, for example, include most frequently used functions in one widget. As opposed to the menu based approach for financial organization transactions, such widgets allow for faster processing, and avoid wastage of time navigating menus across banking verticals. Menus are typically designed according to banking verticals and not according to an end user's needs. So, in order to serve a bank customer, a bank employee may need to navigate through several menus to effect a simple transaction. As an example, if a bank user deposits a bank draft or a banker's cheque from the same bank, and then wishes to withdraw cash, the bank employee will first need to work with the draft deposit functions, then would need to navigate to cash withdrawal functions. According to one embodiment, a deposit and withdrawal widget is designed, which includes deposits and withdrawals, and account balance in a single view. Using this widget, the bank employee completes the bank user's transactions in a single window. It is noted that each function, viz. deposit, withdrawal, account balance are finite functions, i.e. would not need to call other functions for complete execution, and can be advantageously organized into a single widget in environments where most customers tend to deposit and withdraw money.

Furthermore, the mutually exclusive and exhaustive finite function widgets allow for actions that are based on one or more contexts of operations, including but not limited to, role of a bank employee using the widgets, time of the day, type of transactions being worked upon, a bank customer's profile, one or more preset preferences, and the like. Since, all functions are finite, known (exhaustive), and do not overall because the functions are mutually exclusive, such an arrangement results in an unambiguous and transparent availability of functions possibly required for a given context. For example, a bank's corporate customer is an organization having a finance executive responsible for maintaining appropriate balances across the organizations several accounts within, and across one or more countries. The executive may check the rate of Great Britain Pound (GBP) at 0800 GMT, and then set up transfer of monies across various accounts. Function designed for checking foreign currency rates therefore is designed to have a citation to the money transfer function. According to some embodiments, availability of potentially usable function is indicated to the user by a display or a prompt or any other attention directing technique while the user is still on a particular function. According to various embodiments, several variations and combinations of contexts are used to define actions (or functions) relevant to such contexts or combination of contexts, and in some embodiments, such functions are made available for use when conditions for one or more relevant context are met, thereby enabling context based actions.

As discussed above, in various embodiments, widgets include optional portions for displaying information and widgets according to the current context, for example, transaction history, or registration information and the like, in addition to the information being utilized by the widget.

Furthermore, widgets are designed to optimize fields (e.g. for information/data input, edit or display) through a careful study of all such fields across all functions or roles.

In various embodiments, widgets include optional portions for displaying information and widgets according to the current context, for example, transaction history, or registration information and the like, in addition to the information being utilized by the widget.

According to several embodiments, the widgets are customizable by users. That is, various fields may be customized by an end user. Widgets are configured to present rich data, including graphs, pie charts and other multimedia data.

Several embodiments enable users in handling exception management, context aware transactions and reconciliation in an easy and intuitive manner, for example using appropriate widgets. An example, an elderly customer walks in the bank and wants to perform a cash withdrawal, the system is able to automatically prioritize the authorization required for the transaction based on the age of the customer.

The real time data display module 214 is configured to provide real time information pertinent to an entity, for example a customer, a bank employee and the like. For example, along with a pre-populated widget for enabling a transaction provided by the UI element module 212, the real time data display module 214 provide for displaying widgets and information related with, and/or based on one or more of the entity, a transaction history of the entity, the transaction type, and the transaction details, or a combination of the above. For the example described above with respect to the search module 210, the real-time data display module 214, in one embodiment, determines that the entity which is a customer has made several cash deposits towards commodity trading. Accordingly, the real-time data display module 214 provides commodity information for the day, past commodity trading information for the customer, and commodity trading products available from the bank. In some embodiments the module 214 provides an analysis of the commodity trading over a relevant time period, including data for real time analysis and forecasting. In some embodiments, the module 214 provides information for making informed decision—such as a comparison of expected returns from commodity trading versus a fixed deposit or other decision making information. In some embodiments, the module 214 collaborates with the UI element module 212 to identify widgets that aid the users to post transactions, for example. In one embodiment, the module 214 allows for utilizing one or more of the features described above to provide at least one alternate pre-populated widget apart from a widget for cash deposit, for example a commodity trading transaction widget. The bank employee or the customer may then decide to complete the transaction for cash deposit, or alternately, for commodity trading as desired. Accordingly, the module 214 enables information, analysis, decision and transaction features in a real time manner for the bank employee and the customer.

The workspace customizer 216 provides widgets and information to be displayed to a user of the apparatus 100, including a bank employee, a customer who uses a self-service option, a system administrator of the apparatus 100, a manager for bank employees and the like. The workspace customizer 216 may be used to customize workspaces based on a preference. The preference includes one or more of, role of user of the workspace with respect to the banking organization, time of use of the workspace and, a selection of the banking organization. The workspace may be customized by different entities to a varying degree based on the role of the user with respect to the banking organization. Identity of the user customizing the workspace may be verified using, for example the identity verification module 218. For example, while a system administrator could completely configure a workspace and widgets or information, a bank employee may customize his/her workspace with respect to a lesser number of widgets or information, and a customer may be allowed to configure an even lesser number of widgets or information. According to various embodiments, various roles mapped to user (e.g. a bank employee) from across different applications are displayed here. In one embodiment, the user selects a particular role and gets redirected to the role specific workspace. According to one embodiment, a user selects widgets from across roles, and saves widgets into a custom workspace, in which widgets from across roles/applications are rendered. The custom workspace is configured by, for example, using the workspace customizer 216.

The identity verification module 218 includes functionality for role identification of bank employees, for example based on login credentials, biometric verification and similar methods known in the art. The identify verification module 218 further includes functionality for verifying identity of a customer or a bank employee for authorizing or completing a particular transaction. In one embodiment, the module 218 is configured to compare a customer signature stored in the bank records (e.g. in the data storage 106 of FIG. 1) and a signature executed by the customer at the time of authorizing a transaction. In one embodiment, the signature at the time of the transaction is executed on a touch screen device. In another embodiment, the module 218 is configured to compare a voice recognition signature from a previously stored customer voice recognition signature, and voice recognition signature captured at the time of authorizing the transaction.

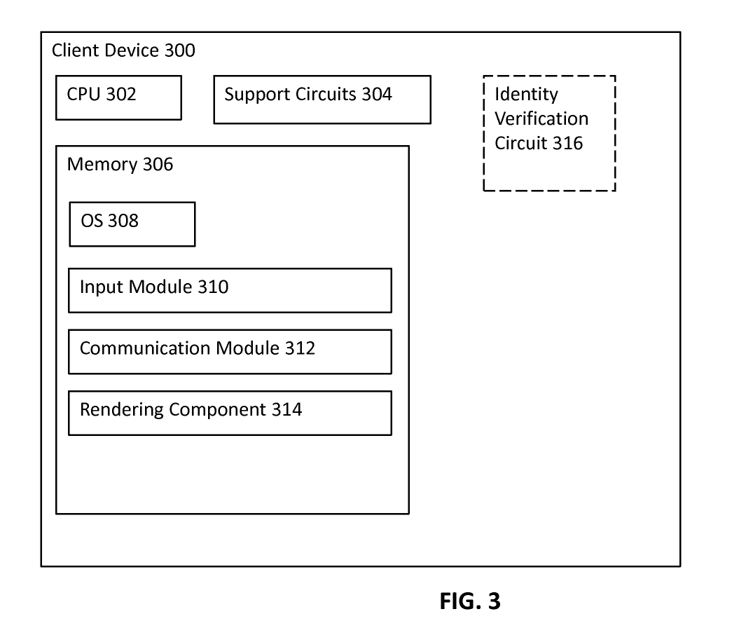

FIG. 3 depicts a block diagram of a client device 300, similar to the client device 102 of FIG. 1, according to an embodiment. The client device 300 is a type of computing device (e.g., a laptop, a desktop, a Personal Digital Assistant (PDA) and/or the like) known to one of ordinary skill in the art. The CPU 302 may comprise one or more commercially available microprocessors or microcontrollers that facilitate data processing and storage. The various support circuits 304 facilitate the operation of the CPU 302 and include one or more clock circuits, for example a meeting timer, power supplies, cache, input/output circuits, displays, including touch sensitive displays, touch sensitive input circuits and the like. The client device 300 further includes a memory 306. The memory 306 comprises at least one of Read Only Memory (ROM), Random Access Memory (RAM), disk drive storage, optical storage, removable storage and/or the like. The memory 306 includes an Operating System (OS) 308, an input module 310, a communication module 312, and a rendering component 314. In one embodiment the client device includes an identity verification circuit 316 for verifying identity of a person, for example a customer, a bank employee, a system administrator and the like. The verification circuit 316 includes, without limitation, a fingerprint reader, voice recognition reader, a facial recognition reader, an iris recognition reader and other known circuitry for identity verification.

According to some embodiments, the operating system (OS) 308 generally manages various computer resources (e.g., network resources, file processors, and/or the like). The operating system 308 is configured to execute operations on one or more hardware and/or software modules, such as Network Interface Cards (NICs), hard disks, virtualization layers, firewalls and/or the like. Examples of the operating system 308 may include, but are not limited to, Linux, Mac OSX, BSD, UNIX, Microsoft Windows, and the like.

According to various embodiments, the input module 310 receives input from a use of the client device 300. Users of the client device include bank employees, system administrators for the apparatus 100, bank's customers and the like. The input received includes, for example, search query provided to the search module 210, confirmation of a transaction provided to UI Element module 212, customization preferences provided to workspace customizer 216 and identity information provided to identity verification module 218.

The communication module 312 communicates the input received, for example by the input module 310, to corresponding elements on the application server 200. For example, the communication module 312 communicates the search query to the search module 210, confirmation of a transaction to the UI Element module 212, customization preferences to the workspace customizer 216 and identity information to the identity verification module 218.

The rendering component 314 renders information, UI Elements or widgets on the client device 300 for display to a user of the client device 300, for example, based on the specifications received from the workspace customizer 216. In some embodiments, the rendering component is a web browser. In certain other embodiments, the rendering component is a native application on the client device 300.The rendering component provides a consistent user experience for users across different computing devices, such as tablets, laptops, desktops, mobile devices and the like.

FIGS. 1, 2 and 3 illustrate embodiments with various components of the application server (104 or 200), the client device (102 or 300) and the data storage 106 in one configuration. The components or the functionality described herein may be reconfigured to in several different configurations without deviating from the scope and spirit of the present invention. For example, in one embodiment, the data storage 106 resides within the application server 200. In another embodiment, the identity verification module 218 may reside on another component, e.g. an identity verification server (not shown in the Figures) on the network. All such equivalent configurations are embodiments envisioned within the scope of the present invention.

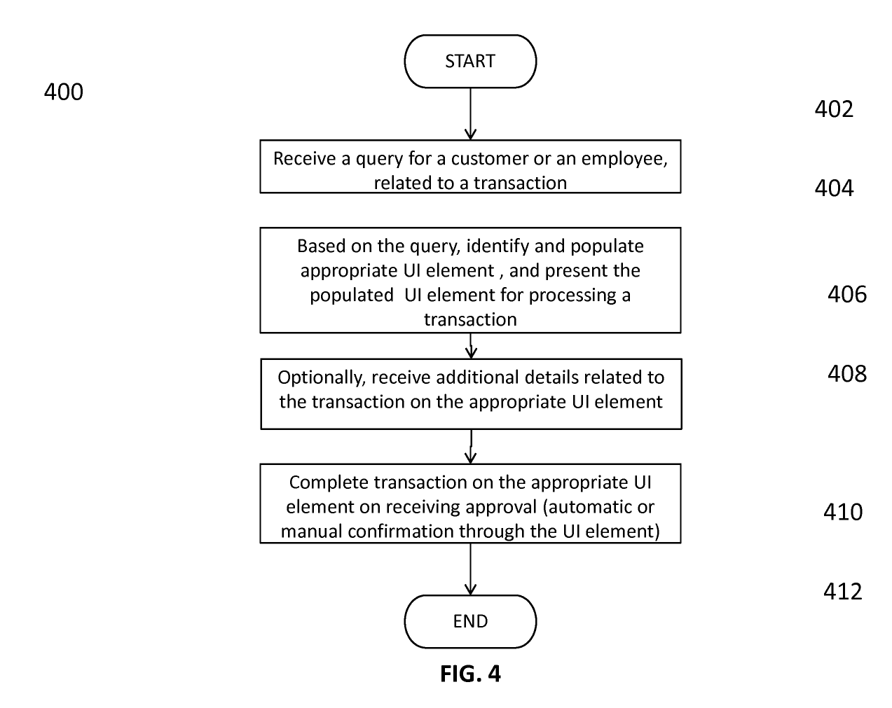

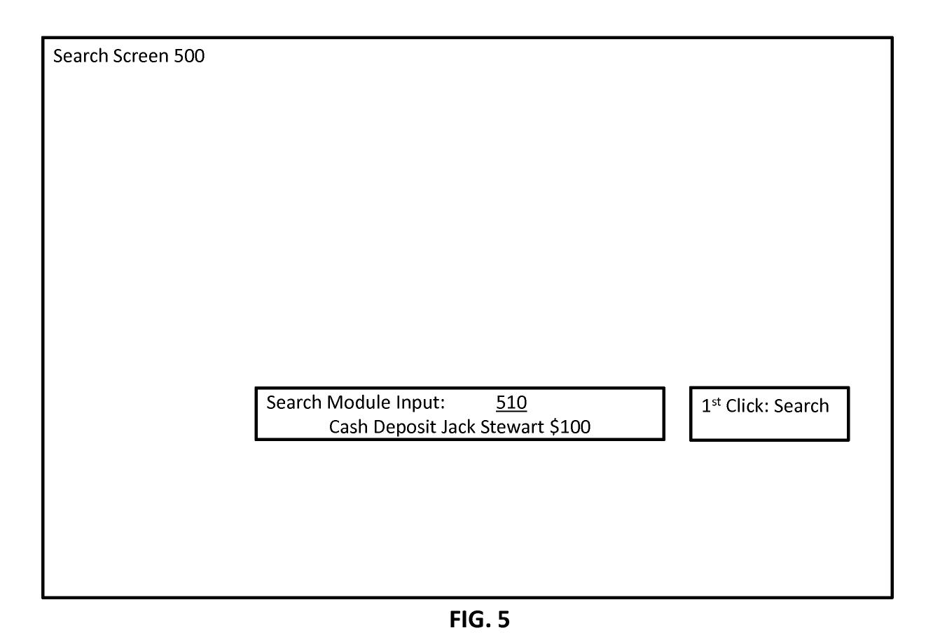

FIG. 4 depicts a method for efficient banking using the apparatus of FIG. 1, according to one or more embodiments of the invention. The method 400 enables single or double click banking transactions by using a search query to identify a transaction type, selecting a widget for the transaction, pre-populating the widget based on the search query and presenting it to a user, according to one or more embodiments of the invention. Some aspects of the method 400 are related with respect to FIGS. 5-9.

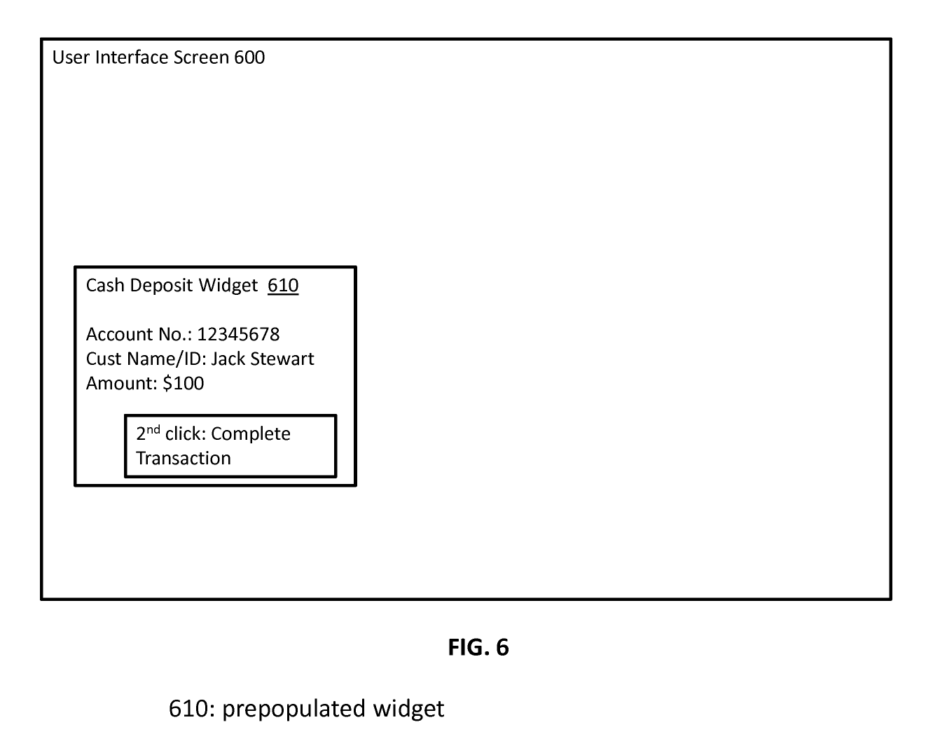

The method 400 starts at step 402, and proceeds to step 404. At step 404, the method 400 receives a query related to a transaction for a customer or an employee. The query includes identification information for the customer, or the bank employee, for example. The query further includes information about a transaction type, for example, cash deposit or cash withdrawal. The query may further include a transaction amount including a currency type. For example, the query in the embodiment of FIG. 5 is “cash deposit Jack Stewart $100”, and identifies a customer Jack Stewart, identifies a transaction type cash deposit and a transaction amount of 100 in US Dollars. At step 406, the method 400 identifies a widget or UI Element for the transaction and populates the widget with the customer information and the transaction information. The populated UI element is presented to the user for further processing the transaction. For example, the embodiment of FIG. 6 illustrates the cash deposit widget (selected using the transaction type from the query) with pre-populated account information for Jack Stewart, and the transaction amount.

At step 408, the method 400 receives additional details related to the transaction. In one embodiment, the additional details are used to further populate the widget. According to some embodiments, the step 408 is optional, for example, in cases where no further information or details are required to complete the transaction, the step 408 is not implemented. In several embodiments, the additional information includes information related to the transaction, such as, for example, if a customer deposits in different currencies, providing the exchange rate between such currencies may be required. According to several embodiments, the additional details provided include information about the customer, for example, birthday or anniversary. In other embodiments, additional details include customer investment or transaction preferences that are utilizable by a user (bank employee) for suggesting additional products or transactions to the customer. According to several other embodiments, additional details include data for real time analysis and forecasting. According to several embodiments, additional details include decision making comparative information. According other embodiments, additional data includes social integration information, for example posted on social networking platforms. Such information allows a bank employee to suggest bank's products based on the customer's activities posted on the social networking platforms.

At step 410, the method 400 completes the transaction on receiving requisite approvals for completing the transaction. The method 400 ends at step 412. Advantageously, the method 400 enables 2-step and/or 2-click banking. For example, in FIG. 6, the transaction is completed by one of the buttons illustrated within the both marked “Complete Txn”. In various embodiments, the confirmation of transaction is completed automatically, for example, by virtue of providing a customer identification parameter such as a signature, or a voice recognition signature clip. In other embodiments, a manual input confirming the transaction is required. According to several embodiments, the transaction is completed after due verification of the customer credentials, including but not limited to verification techniques such as fingerprint identification, voice recognition, signature verification, iris recognition and other techniques generally known in the art.

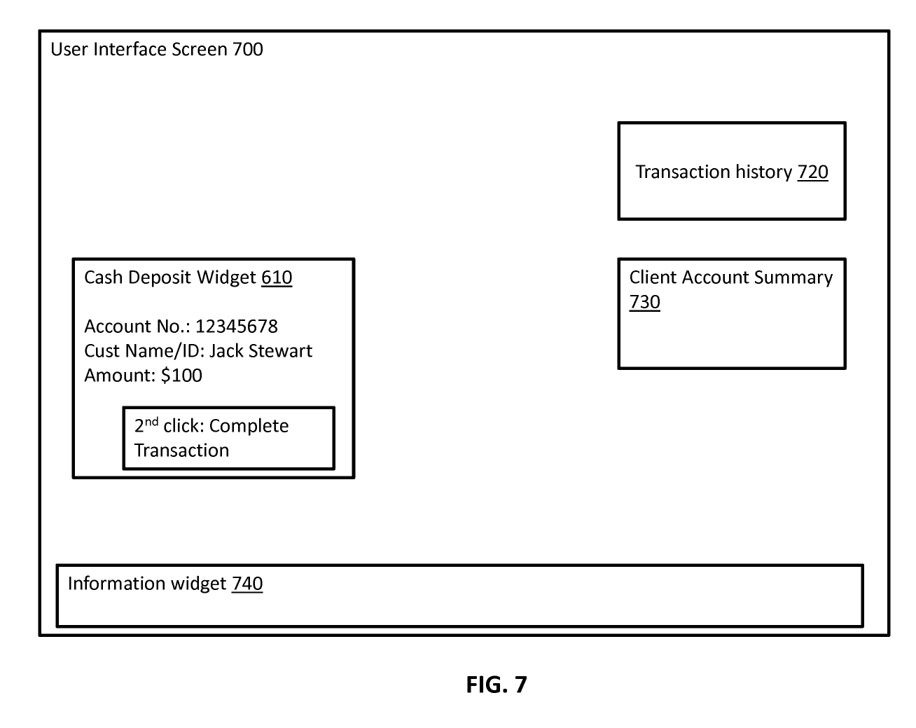

FIGS. 5, 6, 7, 8 and 9 illustrate, certain features provided by the apparatus 100, according to an embodiment of the invention. FIG. 5 illustrates a search screen 500 for a bank employee. Various features of the search screen widget identifies the role of the bank employee, and in the example illustrated by FIG. 5, the role selected is that of a teller. The search screen 500 includes a dialog box 510. The search dialog box 510 is used to receive search queries, and in one embodiment, the search query is processed by the input module 310 of FIG. 3, and communicated to the application server 200 by the communication module 312. The search module 210 identifies the user by searching in the data storage 106, while the UI Element module 212 selects the appropriate UI element or widget for the transaction, the UI Element module further populates the widget with information about the user and the transaction as made available by the search module 210, and sends the information to the communication module 312. The rendering component 314 then renders or displays the pre-populated widget on the customer device 300. For example, as illustrated in the embodiment of FIG. 6, the cash deposit widget 610 on a user interface screen 600 is pre-populated with the relevant information. According to certain embodiments, the realtime data display module 214 provides additional information and/or widgets to the rendering component 314 based current context such as customer identity, customer transaction history, transaction currently requested and similar information using the principles of information, analysis, decision and transaction as discussed earlier. The rendering component displays these additional widgets or information on the client device 300. For example, as illustrated in user interface screen 700 by the embodiment of FIG. 7, it is identified from the customer account summary 730 that the customer, Jack Stewart has a transaction history 720 of investment in the stock market and the currency markets. Accordingly, information widget 740 presenting stock quotes and currency rates are presented on the display. According to several other embodiments illustrated by FIGS. 5-7, other relevant information is provided in real time. For example, the customer attributes may include customer's personal details such as birthday or marriage anniversary, which if greeted appropriately, helps in creating a stronger relationship between the customer and the bank. Further, such occasions may provide opportunities for the bank employee to sell related products such as insurance, loans (vacation, vehicle etc.) to the customer.

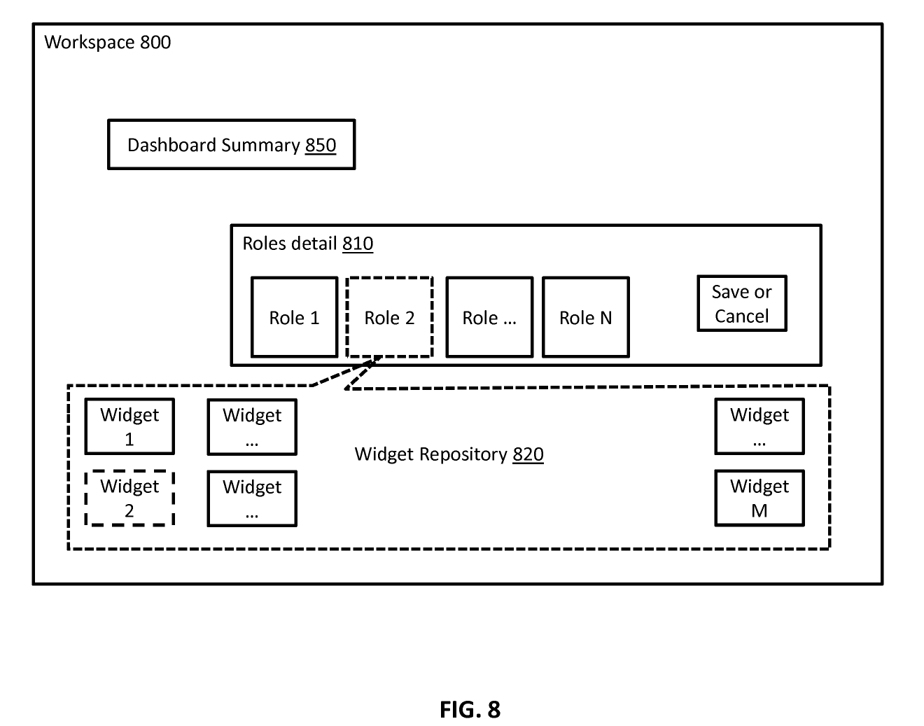

FIG. 8 illustrates how the workspace 800 of an employee may be customized by the bank and/or the employee. An employee may have to perform different roles, such as that of teller and that of an insurance officer at different times of the day and multiple roles at the same time. A role detail 810 of the employee is used to select different widgets from the widget repository 820. These different widgets may be provided in the workspace of the employee to enable the employee to perform different roles at the same time. Alternatively, different workspaces customized to role to be played at a specific time may be provided to the employee. According to some embodiments, the bank management may push real time information to the bank employee relating to the employee's performance, expected performance, desired focus and similar messaging in an easy manner, for example, using the employee performance and messaging summary dashboard 850. For example, the summary dashboard 850 includes the number of transactions that the bank employee has authorized, and the number of transactions that are pending the employee's authorization. Information may also include operational information such as cash in hand and work schedule.

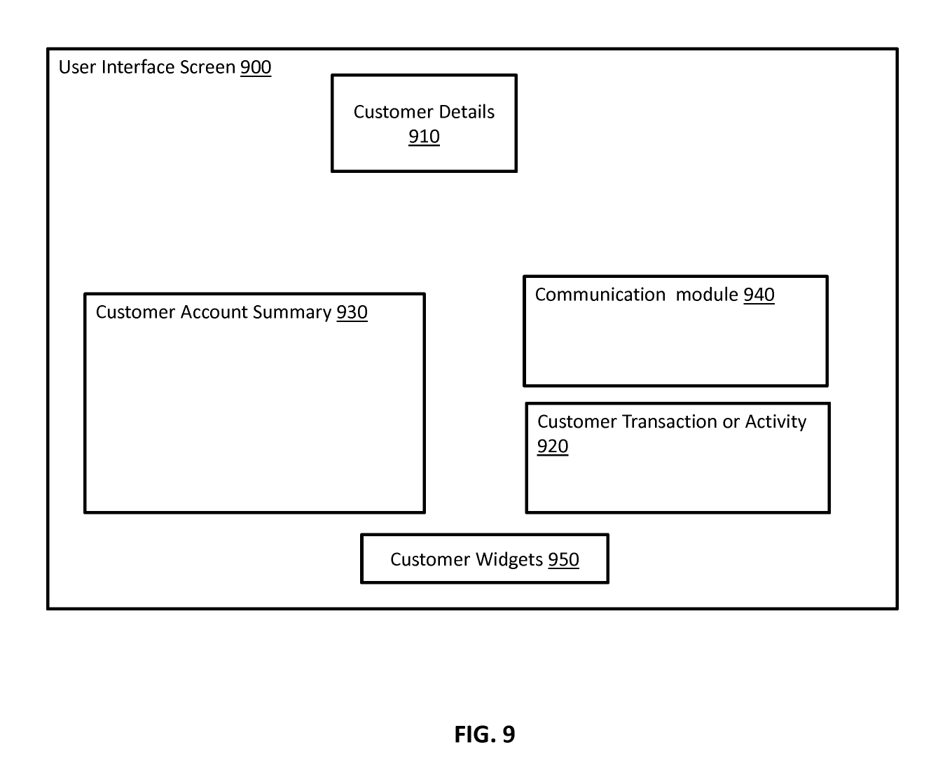

FIG. 9 illustrates the use of the apparatus 100 by a bank customer, according to an embodiment. The embodiment illustrated by FIG. 9 includes a user interface screen 900 of a self-service kiosk at a bank branch, an ATM or other banking locations, and also includes internet or mobile banking by the customer for example at customer's home. The customer widgets 950 provided to a customer is consistent with the privileges of the customer and widgets, information and privileges can be configured, for example, using the workspace customizer 216 of FIG. 2. The embodiment of FIG. 9 illustrates that the customer has a communication module 940 which may be a channel to interact with his/her relationship manager. Other widgets and information included in the UI screen 900 customized for a customer include customer attributes such as customer details 910, customer account summary 930, and transaction widget 920. The transaction widget may be a net transfer enabling widget or a widget for creating a fixed deposit etc.

According to several embodiments, method and apparatus described herein provide for 2 click banking transactions. According to several embodiments, method and apparatus described herein provide widgets according to an information, analysis, decision and transaction role based framework for a bank. Furthermore, in several embodiments, methods and apparatus allow for structuring and accessing the information around the customer. Furthermore, various embodiments described herein provide for easy and intuitive user experience, easy customization, higher efficiency and productivity per user (or bank employee). According to several embodiments, method and apparatus for efficient banking provide structures such that Customer is at the center, shortcuts are enabled for quick data entry, ability to customize employee workspaces, simplify decision making by providing dashboards with access to rich real time data, provide a catalog of functionality that can be updated through a marketplace, provide a single UX across PC and non-PC devices, and focus bank employees on productivity metrics and upsells, and ultimately enable the users (bank employees) to engage with customers in a deep manner.

The embodiments of the present invention may be embodied as methods, apparatus, electronic devices, and/or computer program products. Accordingly, the embodiments of the present invention may be embodied in hardware and/or in software (including firmware, resident software, micro-code, etc.), which may be generally referred to herein as a “circuit” or “module”. Furthermore, the present invention may take the form of a computer program product on a computer-usable or computer-readable storage medium having computer-usable or computer-readable program code embodied in the medium for use by or in connection with an instruction execution system. In the context of this document, a computer-usable or computer-readable medium may be any medium that can contain, store, communicate, propagate, or transport the program for use by or in connection with the instruction execution system, apparatus, or device. These computer program instructions may also be stored in a computer-usable or computer-readable memory that may direct a computer or other programmable data processing apparatus to function in a particular manner, such that the instructions stored in the computer usable or computer-readable memory produce an article of manufacture including instructions that implement the function specified in the flowchart and/or block diagram block or blocks.

The computer-usable or computer-readable medium may be, for example but not limited to, an electronic, magnetic, optical, electromagnetic, infrared, or semiconductor system, apparatus, device, or propagation medium. More specific examples (a non exhaustive list) of the computer-readable medium include the following: hard disks, optical storage devices, a transmission media such as those supporting the Internet or an intranet, magnetic storage devices, an electrical connection having one or more wires, a portable computer diskette, a random access memory (RAM), a read-only memory (ROM), an erasable programmable read-only memory (EPROM or Flash memory), an optical fiber, and a compact disc read-only memory (CD-ROM).

Computer program code for carrying out operations of the present invention may be written in an object oriented programming language, such as Java®, Smalltalk or C++, and the like. However, the computer program code for carrying out operations of the present invention may also be written in conventional procedural programming languages, such as the “C” programming language and/or any other lower level assembler languages. It will be further appreciated that the functionality of any or all of the program modules may also be implemented using discrete hardware components, one or more Application Specific Integrated Circuits (ASICs), or programmed Digital Signal Processors or microcontrollers.

The foregoing description, for purpose of explanation, has been described with reference to specific embodiments. However, the illustrative discussions above are not intended to be exhaustive or to limit the invention to the precise forms disclosed. Many modifications and variations are possible in view of the above teachings. The embodiments were chosen and described in order to best explain the principles of the present disclosure and its practical applications, to thereby enable others skilled in the art to best utilize the invention and various embodiments with various modifications as may be suited to the particular use contemplated.

Example Computer System

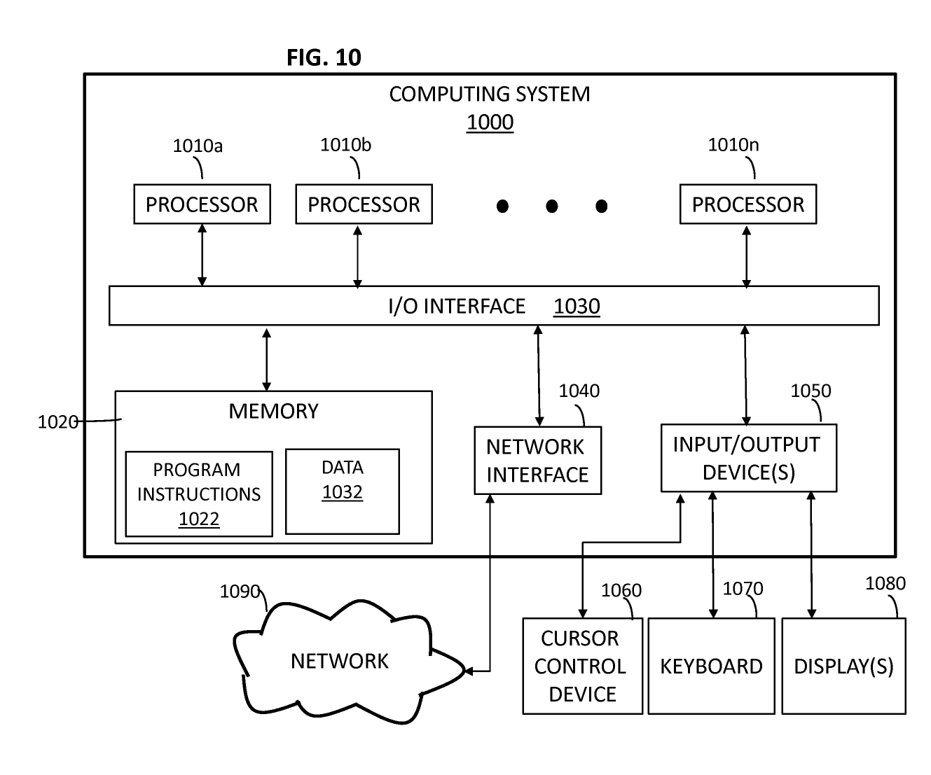

FIGS. 1, 2 and 3 depict computer systems that can be used to implement the method of FIG. 4, according to one or more embodiments of the invention. FIG. 10 depicts a computer system that can be utilized in various embodiments of the present invention to implement the application server 200 and the client device 300, according to one or more embodiments.

Various embodiments of method and apparatus for efficient banking, as described herein, may be executed on one or more computer systems, which may interact with various other devices. One such computer system is computer system 1000 illustrated by FIG. 10, which may in various embodiments implement any of the elements or functionality illustrated in FIGS. 1-9. In various embodiments, computer system 1000 may be configured to implement methods described above. The computer system 1000 may be used to implement any other system, device, element, functionality or method of the above-described embodiments. In the illustrated embodiments, computer system 1000 may be configured to implement method 400, as processor-executable executable program instructions 1022 (e.g., program instructions executable by processor(s) 1010) in various embodiments.

In the illustrated embodiment, computer system 1000 includes one or more processors 1010 coupled to a system memory 1020 via an input/output (I/O) interface 1030. Computer system 1000 further includes a network interface 1040 coupled to I/O interface 1030, and one or more input/output devices 1050, such as cursor control device 1060, keyboard 1070, and display(s) 1080. In various embodiments, any of components may be utilized by the system to receive user input described above. In various embodiments, a user interface (e.g., user interface) may be generated and displayed on display 1080. In some cases, it is contemplated that embodiments may be implemented using a single instance of computer system 1000, while in other embodiments multiple such systems, or multiple nodes making up computer system 1000, may be configured to host different portions or instances of various embodiments. For example, in one embodiment some elements may be implemented via one or more nodes of computer system 1000 that are distinct from those nodes implementing other elements. In another example, multiple nodes may implement computer system 1000 in a distributed manner.

In different embodiments, computer system 1000 may be any of various types of devices, including, but not limited to, a personal computer system, desktop computer, laptop, notebook, or netbook computer, mainframe computer system, handheld computer, workstation, network computer, a camera, a set top box, a mobile device, a consumer device, video game console, handheld video game device, application server, storage device, a peripheral device such as a switch, modem, router, or in general any type of computing or electronic device.

In various embodiments, computer system 1000 may be a uniprocessor system including one processor 1010, or a multiprocessor system including several processors 1010 (e.g., two, four, eight, or another suitable number). Processors 1010 may be any suitable processor capable of executing instructions. For example, in various embodiments processors 1010 may be general-purpose or embedded processors implementing any of a variety of instruction set architectures (ISAs), such as the x96, PowerPC, SPARC, or MIPS ISAs, or any other suitable ISA. In multiprocessor systems, each of processors 1010 may commonly, but not necessarily, implement the same ISA.

System memory 1020 may be configured to store program instructions 1022 and/or data 1032 accessible by processor 1010. In various embodiments, system memory 1020 may be implemented using any suitable memory technology, such as static random access memory (SRAM), synchronous dynamic RAM (SDRAM), nonvolatile/Flash-type memory, or any other type of memory. In the illustrated embodiment, program instructions and data implementing any of the elements of the embodiments described above may be stored within system memory 1020. In other embodiments, program instructions and/or data may be received, sent or stored upon different types of computer-accessible media or on similar media separate from system memory 1020 or computer system 1000.

In one embodiment, I/O interface 1030 may be configured to coordinate I/O traffic between processor 1010, system memory 1020, and any peripheral devices in the device, including network interface 1040 or other peripheral interfaces, such as input/output devices 1050. In some embodiments, I/O interface 1030 may perform any necessary protocol, timing or other data transformations to convert data signals from one components (e.g., system memory 1020) into a format suitable for use by another component (e.g., processor 1010). In some embodiments, I/O interface 1030 may include support for devices attached through various types of peripheral buses, such as a variant of the Peripheral Component Interconnect (PCI) bus standard or the Universal Serial Bus (USB) standard, for example. In some embodiments, the function of I/O interface 1030 may be split into two or more separate components, such as a north bridge and a south bridge, for example. Also, in some embodiments some or all of the functionality of I/O interface 1030, such as an interface to system memory 1020, may be incorporated directly into processor 1010.

Network interface 1040 may be configured to allow data to be exchanged between computer system 1000 and other devices attached to a network (e.g., network 1090), such as one or more external systems or between nodes of computer system 1000. In various embodiments, network 1090 may include one or more networks including but not limited to Local Area Networks (LANs) (e.g., an Ethernet or corporate network), Wide Area Networks (WANs) (e.g., the Internet), wireless data networks, some other electronic data network, or some combination thereof. In various embodiments, network interface 1040 may support communication via wired or wireless general data networks, such as any suitable type of Ethernet network, for example; via telecommunications/telephony networks such as analog voice networks or digital fiber communications networks; via storage area networks such as Fibre Channel SANs, or via any other suitable type of network and/or protocol.

Input/output devices 1050 may, in some embodiments, include one or more display terminals, keyboards, keypads, touchpads, scanning devices, voice or optical recognition devices, or any other devices suitable for entering or accessing data by one or more computer systems 1000. Multiple input/output devices 1050 may be present in computer system 1000 or may be distributed on various nodes of computer system 1000. In some embodiments, similar input/output devices may be separate from computer system 1000 and may interact with one or more nodes of computer system 1000 through a wired or wireless connection, such as over network interface 1040.

In some embodiments, the illustrated computer system may implement any of the methods described above, such as the methods illustrated by the flowchart of FIG. 4. In other embodiments, different elements and data may be included.

Those skilled in the art will appreciate that computer system 1000 is merely illustrative and is not intended to limit the scope of embodiments. In particular, the computer system and devices may include any combination of hardware or software that can perform the indicated functions of various embodiments, including computers, tablet PCs, network devices, Internet appliances, PDAs, wireless phones, pagers, etc. Computer system 1000 may also be connected to other devices that are not illustrated, or instead may operate as a stand-alone system. In addition, the functionality provided by the illustrated components may in some embodiments be combined in fewer components or distributed in additional components. Similarly, in some embodiments, the functionality of some of the illustrated components may not be provided and/or other additional functionality may be available.

Those skilled in the art will also appreciate that, while various items are illustrated as being stored in memory or on storage while being used, these items or portions of them may be transferred between memory and other storage devices for purposes of memory management and data integrity. Alternatively, in other embodiments some or all of the software components may execute in memory on another device and communicate with the illustrated computer system via inter-computer communication. Some or all of the system components or data structures may also be stored (e.g., as instructions or structured data) on a computer-accessible medium or a portable article to be read by an appropriate drive, various examples of which are described above. In some embodiments, instructions stored on a computer-accessible medium separate from computer system 1000 may be transmitted to computer system 1000 via transmission media or signals such as electrical, electromagnetic, or digital signals, conveyed via a communication medium such as a network and/or a wireless link. Various embodiments may further include receiving, sending or storing instructions and/or data implemented in accordance with the foregoing description upon a computer-accessible medium or via a communication medium. In general, a computer-accessible medium may include a storage medium or memory medium such as magnetic or optical media, e.g., disk or DVD/CD-ROM, volatile or non-volatile media such as RAM (e.g., SDRAM, DDR, RDRAM, SRAM, etc.), ROM, etc.

The methods described herein may be implemented in software, hardware, or a combination thereof, in different embodiments. In addition, the order of methods may be changed, and various elements may be added, reordered, combined, omitted, modified, etc. All examples described herein are presented in a non-limiting manner. Various modifications and changes may be made as would be obvious to a person skilled in the art having benefit of this disclosure. Realizations in accordance with embodiments have been described in the context of particular embodiments. These embodiments are meant to be illustrative and not limiting. Many variations, modifications, additions, and improvements are possible. Accordingly, plural instances may be provided for components described herein as a single instance. Boundaries between various components, operations and data stores are somewhat arbitrary, and particular operations are illustrated in the context of specific illustrative configurations. Other allocations of functionality are envisioned and may fall within the scope of the embodiments described. Finally, structures and functionality presented as discrete components in the example configurations may be implemented as a combined structure or component. These and other variations, modifications, additions, and improvements may fall within the scope of embodiments as described.

The foregoing is directed to embodiments of the present invention, other and further embodiments of the invention may be devised without departing from the basic scope thereof.

1. A method for managing banking, the method comprising:
decomposing data processing of a banking organization into a plurality of functions; and
providing a plurality of widgets, each of the plurality of widgets performing a banking operation, and each of the plurality of widgets comprising at least one of the plurality of finite functions,
wherein the plurality of widgets exhaustively represent the data processing of the banking organization exhaustively and perform mutually exclusive banking operations.

2. An apparatus for customizing a workspace of a computing terminal of a banking organization, the apparatus comprising:
a repository of a plurality of widgets;
a workspace customizer for providing at least one of the plurality of widgets according to a preference, the preference comprising at least one of role of user of the workspace with respect to the banking organization, time of use of the workspace, or a selection of the banking organization; and
a rendering component for rendering the at least one of the plurality of widgets in the workspace, wherein the plurality of widgets are mutually exclusive and represent data processing of the banking organization exhaustively.

3. The apparatus of claim 2 further comprising an identity verification module for verifying identity of user customizing the workspace.

4. The apparatus of claim 3, wherein the workspace customizer provides access to the at least one of the plurality of widgets according to identity of the user customizing the workspace.

5. A method for banking, comprising:
providing at least one of a plurality of widgets based on a current context, each of the plurality of widgets comprising at least one of a plurality of data processing of a banking operation,
wherein the plurality of widgets exhaustively represent data processing of a banking organization and perform mutually exclusive banking operations,
and wherein the current context comprises at least one of operation type, customer identity, a customer attribute, date of the banking operation and, currency of the banking operation.

6. The method of claim 5 wherein the customer attribute may comprise at least one of personal details of customer, transaction history of customer, or attributes of account of the customer.
